(19) United States
(12) Patent Application Publication
(10) Pub. No.: US 2017/0182917 A1
(43) Pub. Date: Jun. 29, 2017

(54) SEAT SUSPENSION SYSTEM, APPARATUS, AND METHOD OF USING SAME

(71) Applicant: CDG COAST DYNAMICS GROUP LTD., Saanichton (CA)

(72) Inventors: Paul Wesley TAYLOR, Victoria (CA); Daniel Bennett CHARBONEAU, Victoria (CA); James Steven CANOVA, Victoria (CA); Timothy REES, Victoria (CA)

(21) Appl. No.: 15/308,813

(22) PCT Filed: May 6, 2015
(86) PCT No.: PCT/CA2015/050396

§ 371 Date: Nov. 3, 2016

Related U.S. Application Data
(60) Provisional application No. 61/989,406, filed on May 6, 2014.

(51) Int. Cl. B60N 2/52; F16F 9/32; F16F 9/46

(52) U.S. Cl. CPC B60N 2/522; F16F 9/46; F16F 9/325; F16F 9/16

(57) ABSTRACT

A suspension system has an isolator cylinder with a primary reservoir having a primary reservoir volume, a secondary reservoir having a secondary reservoir volume, a manifold and a primary duct fluidly connecting the primary and secondary reservoirs for controlling the flow rate of the fluid between the primary and secondary reservoirs, and optionally a valve for controlling a flow rate of a fluid through the duct, and a control system for operating the valve. A shock absorption system for a vehicle seat is provided comprising an isolator with at least one secondary pneumatic reservoir connected with a fluid duct to the primary reservoir of an isolator. The reservoir volumes, length and cross sectional area of the connecting duct and fluid flow control valves may be determined using methods including algorithms, experimental testing and models to determine the optimal values to achieve consistent shock mitigation across a range of seat loads.

### CROSS-REFERENCE TO RELATED APPLICATIONS

This application is related and claims priority to U.S. Provisional Patent Application Ser. No. 61/989,406 filed May 6, 2014, which is hereby incorporated herein by reference in its entirety.

### TECHNICAL FIELD

The present disclosure technically relates to shock absorption systems and apparatus. More specifically, the present disclosure technically relates to isolator systems and apparatus for use in shock mitigation in vehicle applications such as vehicle seat shock absorption systems and apparatus for marine, air, land and space vehicle seats. Even more specifically, the present disclosure technically relates to hydro-pneumatic cylinder isolator systems and apparatus having multiple pneumatic reservoir volumes for shock absorption and include isolator system embodiments having multiple pneumatic reservoir volumes which may be selectively engaged at optimal control switching points to provide similar force mitigation for a variety of different payloads.

### BACKGROUND

Many related art technologies are currently utilized for vehicle suspension in general. These related art technologies usually involve either pneumatic or hydro pneumatic suspension with passive or semi-active control over the suspension stiffness and damping. Other related are systems include supplemental accumulators or dampers.

For instance, Deo and Suh in PNEUMATIC SUSPENSION SYSTEM WITH INDEPENDENT CONTROL OF DAMPING, STIFFNESS AND RIDE-HEIGHT (icad-2006022, 4^{TH} International Conference on Axiomatic Design, Firenze Jun. 13-16, 2006) (hereinafter “Deo”) disclose a variable air volume pneumatic system with variable stiffness and ride height achieved by pumping air in and out across multiple volumes.

Also, U.S. Pat. No. 5,141,244 to Clotault et al. of Automobiles Peugeot (hereinafter “Peugeot”), discloses a hydro pneumatic suspension system for vehicles with an accumulator and damper for each vehicle wheel, and supplemental hydro pneumatic accumulators for each axle for firmer suspension when the supplemental units are switched out and softer suspension when they are switched in.

In addition, U.S. Pat. No. 4,664,410 Richard to Automobiles Peugeot and Citroen (hereinafter “Citroen”) discloses an oleo pneumatic suspension system for motor vehicles with a suspension cylinder and hydraulic accumulator and damper for each wheel.

Finally, Giliomee, Els and van Niekerk in Anelastic Model of a Twin Accumulator Hydro-pneumatic Suspension System (R&D Journal, 2005, 21 (2) incorporated in the SA Mechanical Engineer) provide a mathematical model for a semi-active twin suspension system with all valves open to evaluate performance criteria.

The related art does not provide a technique for providing a simple passive or semi-active control system for suspension systems having multiple reservoirs controllable in adverse environments, such as high speed marine, land, or air vehicles operating in variable weather and lighting. One company, Shockwave Seats, discloses a static modification to reduce canister volume by adding filler “pills” into the air chamber as a one-time “set-up” to suit the vessel, seating location in the vessel, and anticipated operating conditions and user preference but does not provide for external control of the suspension system after installation or during use.

While these background examples may in some cases relate to twin suspension systems for motor vehicles, they fail to disclose a system or an apparatus adapted for use with a single suspended component such as a seat, nor for a seat in a marine vehicle, and particularly not for a single native hydro-pneumatic isolator in a seat for a marine vehicle, that is capable of optimally controlling a switching point for addition to the system of a second or plurality of supplemental cylinders or reservoirs to achieve consistent shock mitigation for a variety of payloads. Related art twin suspension technology has not been known to be adapted for use with high speed marine vehicles or even for single seat isolator systems. As such, a long-felt need has been experienced in the related art for a system and apparatus that overcomes the inability to provide consistent shock mitigation across multiple payloads with a simple, adverse environment resistant multiple suspension passive system on a marine vehicle seat.

Pressure and damping adjustments may be used to accommodate variances in payload weight and environmental conditions. Pressure and/or damping adjustments typically offer negligible performance advantages when compared to volume adjustments. Conventional semi-active damping-controlled isolators are typically expensive to manufacture and have typically failed to provide the desired increased performance of additional volume reservoir systems. There is a need, therefore, to meet the demands of use on watercraft where simplicity of operation (so as to be usable in adverse conditions day or night) and resistance to extreme marine environmental conditions are desired.

### SUMMARY

In addressing many of the problems experienced in the related art, such as expensive manufacture, complex operation leading to operator errors in selecting settings, inefficient fluid flow from reservoirs and through connecting passageways, the present disclosure generally involves additional volume reservoirs with: optimized passageway size/shape (restrictions minimize effectiveness of additional volume reservoirs); optimized reservoir volume(s), and control switching points; and simple and easily understood and operated adjustment controls. The presently disclosed isolator systems and apparati are beneficial for use with land vehicles, aircraft, spacecraft, and watercraft, such as for suspending single component loads such as seats in such vehicles, aircraft, spacecraft and watercraft. In one embodiment, systems and methods according to the present disclosure may desirably be particularly beneficial for shock mitigation in high speed marine vehicle seats. In one such exemplary embodiment, many types of vehicles (including but not limited to land, water and air vehicles) may desirably benefit from an installation or a retrofit with isolator systems such as hydro-pneumatic cylinder isolator systems according to the present disclosure so as to desirably provide for mitigation of shock forces transferred to seat occupants or users particularly during use in adverse conditions.

In one embodiment according to the present disclosure, a suspension system comprises an isolator cylinder such as a hydro-pneumatic isolator cylinder; a primary reservoir comprising a primary reservoir volume, a secondary reservoir comprising a secondary reservoir volume, an end cap attached to the primary reservoir of the isolator cylinder and comprising a primary duct opening fluidly connected to a primary duct, a primary duct connecting the primary reservoir to the secondary reservoir, and a manifold through which the primary duct passes, wherein at least one of the primary duct opening and the primary duct are configured to control a flow rate of a fluid through the primary duct between the primary and secondary reservoirs. In one such embodiment, the primary duct comprises a cross sectional area and a length such that a fluid flowing through the primary duct between the primary and secondary reservoirs does not contribute to a damping of the isolator cylinder. In a further embodiment, the primary duct comprises a diameter D and a length L such that a ratio of L/D is less than about 24. In yet another embodiment, the primary reservoir additionally comprises a primary piston having a cross sectional area Aₚᵢₛₜₒₙ, and the primary duct comprises a cross sectional area A_{duct} and a Length L, such that A_{duct}≧C₁Aₚᵢₛₜₒₙ Vₘₐₓ; wherein

A_{duct} is the cross sectional area of the primary duct in square inches,

Aₚᵢₛₜₒₙ is the cross sectional area of the primary piston in square inches,

Vₘₐₓ is a maximum velocity of the primary piston in inches/second, and

C₁ is a constant substantially equal to 3.5×10⁻⁴ [s/in].

In another embodiment, the suspension system described above may additionally comprise a valve for controlling a flow rate of a fluid through the duct; and a control system for operating the valve for controlling the flow rate of the fluid between the primary and secondary reservoirs. In a further embodiment, the valve may desirably control a flow rate of the fluid between the primary and secondary reservoirs such as by opening and closing the primary duct, or at least partially opening or closing the primary duct, or further by controllably varying or limiting the rate of fluid flow between the primary and secondary reservoirs between at least upper and lower fluid flow rate limits, for example. In yet a further embodiment, the suspension system may additionally comprise a control system for controlling a flow rate of the fluid between the primary and secondary reservoirs. In one exemplary embodiment, the fluid may comprise at least one of air, nitrogen or another suitable compressible fluid. In another exemplary embodiment the primary reservoir may desirably be disposed entirely within or at least partially within the cylinder, such as within a hydro-pneumatic isolator cylinder, for example. In one such embodiment, the isolator may comprise a native hydro-pneumatic cylinder isolator comprising a primary reservoir disposed within the cylinder, such as a commercially available single cylinder isolator such as the Fox Float 3™ hydro-pneumatic cylinder isolator available from Fox Manufacturing of Scotts Valley, Calif., U.S.A., for example.

Additionally, in one embodiment, the suspension system may be used with an occupant or user seat in at least one of a marine, land or air vehicle to provide for mitigation of shock or force transmitted to the occupant of the seat. In one such embodiment, at least one of the primary duct opening and the primary duct of the suspension system may be configured to control a flow rate of a fluid through the primary duct between the primary and secondary reservoirs to control the suspension response of the suspension system and to desirably provide for improved mitigation of shock or force transmitted to the seat occupant. In another embodiment, the suspension system may comprise a valve for controlling a flow rate of a fluid through the duct; and a control system for operating the valve for controlling the flow rate of the fluid between the primary and secondary reservoirs. In a further embodiment, the control system may include a sensor for measuring an external force due to a weight of the seat in an occupied state, a microprocessor or microcontroller for storing a predetermined force due to a weight of the seat in an unoccupied state and an external force due to a weight of the seat in an occupied state and for determining the weight of an occupant of the seat (such as by comparing the predetermined force due to a weight of the seat in an unoccupied state with the external force due to a weight of the seat in an occupied state), and for controlling the control system, such as a controller for adjusting the valve based on the weight of an occupant of the seat (such as by determining a differential between the external force due to the weight of the seat in an occupied state and the predetermined force due to the weight of the seat in an unoccupied state and adjusting the valve based on the weight differential).

In one embodiment, the control system may also comprise an actuator for operating the valve. In a further such embodiment, the actuator may comprise a switch, which may optionally be manually controlled to operate the valve. In another embodiment, the actuator may comprise a switch and may be automatically controlled to automatically operate the valve, and may also optionally be manually controllable such as for a manual override of the valve operation. In a further embodiment, the control system may also comprise a power source for delivering power to the control system such as for powering at least one of the microprocessor or microcontroller and an actuator.

In another embodiment of the present invention, the suspension system comprises an isolator cylinder such as a hydro-pneumatic isolator cylinder, a primary reservoir comprising a primary reservoir volume, an end cap attached to the primary reservoir of the isolator cylinder and comprising a primary duct opening fluidly connected to a plurality of ducts, and a plurality of secondary reservoirs, each of the plurality of secondary reservoirs comprising a secondary reservoir volume, a plurality of ducts connecting the primary reservoir to the plurality of secondary reservoirs, each of the plurality of ducts comprising a duct cross sectional area, and a duct length, a plurality of valves for controlling a flow rate of a fluid through the each of the plurality of ducts, and at least one manifold through which at least one duct connected to the primary reservoir passes. In another embodiment, the suspension system additionally comprises a control system for controlling a flow rate of the fluid between at least one of the plurality of secondary reservoirs and the primary reservoir.

In a further aspect according to an embodiment of the present invention, a method for absorbing shock transferred to a seat in a vehicle is disclosed. In one such embodiment, the method may be implemented to desirably improve the performance of the suspension system installed in a vehicle seat. In one such embodiment, the method comprises: providing a suspension system comprising an isolator cylinder such as a hydro-pneumatic isolator cylinder, a primary reservoir comprising a primary reservoir volume, at least one secondary reservoir comprising a secondary reservoir volume, at least one duct connecting the at least one secondary reservoir to the primary reservoir, the at least one duct comprising a duct cross sectional area and a duct length, at least one valve for controlling a flow rate of a fluid between the primary and at least one secondary reservoir through the at least one duct, and at least one manifold through which the at least one duct passes. In one such embodiment, the method further comprises providing a control system for controlling a flow rate of the fluid between the primary and the at least one secondary reservoir; providing a stored predetermined force due to the weight of the seat in an unoccupied state, measuring an external force due to a weight of the seat in an occupied state, calculating a force differential between the stored predetermined force and the external force, and adjusting the delivery of a fluid from the reservoirs to the cylinder by controlling the position of the at least one valve in response to the force differential between the stored predetermined force and the external force to control the shock mitigation response of the suspension system.

In yet a further aspect according to an embodiment of the present invention, a method for configuring a suspension system is provided. In one such embodiment, the method comprises: defining a suspension load range (such as an occupant weight range for a seat suspension system) and a shock or input acceleration profile (such as but not limited to at least one of magnitude, duration or period and shape of input acceleration pulses); selecting a suitable native isolator comprising a primary reservoir (such as but not limited to a commercial isolator product and size and an isolator mounting linkage geometry if any); determining a secondary reservoir volume for a secondary reservoir; determining a primary duct cross-sectional area and length for a primary duct fluidly connecting the primary and secondary reservoirs; determining a reservoir pressure such that the isolator does not bottom out or exceed a maximum allowable stroke length for the maximum suspension load during the most extreme or maximum acceleration condition of the shock acceleration profile; and determining a damping coefficient selected to provide a rebound time less than the period of the shock acceleration for the shock acceleration profile. In a further embodiment, the method additionally comprises determining a switching load or weight for a switching valve situated in the primary duct between the primary and secondary reservoirs. In an additional aspect according to an embodiment of the present invention, the method for configuring the suspension system additionally comprises providing a suspension system, the suspension system comprising a native isolator cylinder comprising a primary reservoir; providing the secondary reservoir comprising the secondary reservoir volume; providing an end cap attached to the primary reservoir of the isolator cylinder and comprising a primary duct opening fluidly connected to the primary duct; fluidly connecting the secondary reservoir to the primary reservoir by the primary duct of the cross-sectional area and length determined; and pressurizing the secondary reservoir to the pressure determined. In a further such embodiment, the method may additionally comprise: determining a switching load for a switching valve situated in the primary duct for controlling the flow of a fluid between the primary reservoir and the secondary reservoir; and providing a switching valve disposed in the primary duct for controlling a rate of flow of a fluid between the primary reservoir and the secondary reservoir according to the switching load. In yet a further embodiment, the method may further comprise determining a damping coefficient to provide an isolator rebound time of between 0.2 and 0.5 seconds. In a particular embodiment, the method of configuring a suspension system may desirably provide for use of a maximum available range of isolator travel while preventing bottoming out or over-compression of the isolator over a defined range of suspension loads. In an exemplary embodiment directed to applications in seat suspension systems, the defined range of suspension loads may comprise a defined range of seat occupant weights, for example.

Benefits of systems and methods according to an embodiment of the present disclosure include, but are not limited to, providing a passive isolator system with a primary and at least one secondary reservoir fluidly connected in an efficient manner by at least one passageway or duct comprising a selected and desirably optimal duct cross sectional area, length and reservoir volume to desirably optimize operation of the suspension system to provide shock mitigation to a suspension system load such as a suspended seat occupant, across a range of load or occupant weights.

### BRIEF DESCRIPTION OF THE DRAWINGS

The above, and other, aspects, features, and advantages of several embodiments of the present disclosure will be more apparent from the following Detailed Description as presented in conjunction with the following figures of the Drawings.

FIG. 1 is a side view of a hydro-pneumatic cylinder isolator having a secondary reservoir attached to the primary reservoir of the isolator by a fluid passageway, valve and manifold in accordance with an embodiment of the present disclosure.

FIG. 2 is a perspective view of a hydro-pneumatic cylinder isolator having a secondary reservoir attached to the primary reservoir of the isolator by a fluid passageway, valve and manifold in accordance with an embodiment of the present disclosure.

FIG. 3 is a perspective view of a two (2) position (or detent) passive isolator reservoir volume selector system attached to a marine seat base in accordance with an embodiment of the present disclosure.

FIG. 4 is a rear perspective view of a shock-absorbing vehicle seat incorporating a hydro-pneumatic cylinder isolator having a secondary reservoir in accordance with an embodiment of the present disclosure.

### DETAILED DESCRIPTION

The following description is not to be taken in a limiting sense, but is made merely for the purpose of describing the general principles of exemplary embodiments. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In this Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

In one embodiment, the present disclosure provides a seat suspension isolator (also known as a shock absorber), for use in seats aboard land, air, sea or space vehicles, such as high speed watercraft or marine vehicles for example, and desirably provides for improved shock mitigating performance as compared to conventional isolator designs of both the passive and semi-active (such as computer or otherwise electronically or electro-mechanically controlled), variety. In one such embodiment, a seat suspension isolator according to the present invention may desirably provide improvements in shock mitigation performance across the widest range of seat/occupant weights or other suspension system payloads and environmental conditions. In one embodiment adapted for use in high speed marine vehicle (boat) seat suspension systems, a typical design range for seat occupant/operator or user weight is 100-300 lb; and a typical design range for vehicle deck accelerations (i.e. input shock or impact accelerations) range from 0-16 g. In another embodiment, a suspension system may be applied to use in seat suspension systems in other types of vehicles or seats in various locations subject to movement, shock or impact of vehicular or other types. In an alternative embodiment, suspension systems according to aspects of the present invention may also be adapted for use in shock mitigation suspension of other suspended loads outside of seats, and may typically be applied to mitigate shock for suspension of any suitable single-point suspended load adapted for attachment to an isolator suspension system according to an embodiment of the invention. In one embodiment, a suspension system according to an aspect of the present invention comprises a native isolator comprising a primary fluid reservoir disposed entirely or at least partially within an isolator cylinder, and further comprises at least one secondary fluid reservoir (where the fluid may comprise air, nitrogen or another suitable compressible fluid) connected to the primary fluid reservoir of the isolator cylinder by a primary fluid duct, where the secondary fluid reservoir effectively alters the volume of the primary reservoir. In one such embodiment, the isolator cylinder may comprise a suitable hydro-pneumatic isolator cylinder, such as a native hydro-pneumatic cylinder isolator comprising a primary reservoir disposed within the cylinder, such as a commercially available single cylinder isolator such as the Fox Float 3™ hydro-pneumatic cylinder isolator available from Fox Manufacturing of Scotts Valley, Calif., U.S.A., for example.

In one embodiment, a suspension system according to an aspect of the present invention may desirably provide for improved performance of the isolator by providing at least one specifically sized, additional volume secondary fluid reservoir (in various embodiments) in addition to the primary reservoir of the isolator, which is specifically tuned or configured to the shock inducing environment or input acceleration profile experienced in a desired shock mitigation application, such as for example for a seat suspension system aboard a high speed watercraft, or land vehicle or other specific desired application with a corresponding specific input acceleration profile. In one embodiment, the secondary fluid reservoir may be fluidly connected to the primary reservoir by a primary fluid duct which is fluidly connected to a primary duct opening in an end cap attached to the primary reservoir of the isolator cylinder. In another embodiment, the suspension system may also comprise a fluid flow control valve, and the rate of fluid flow between the primary and secondary reservoirs may be controlled by at least one the cross sectional area and length of the primary duct or duct opening, or by controlling the fluid flow control valve. In one embodiment, a fluid flow control valve may be manually adjusted (such as by a user) or controlled mechanically or electronically, for instance by a PLC, sensor input or vehicle or other installation specific parameters. In one embodiment providing for mechanical and/or electrical/electronic control of the fluid flow rate between primary and secondary reservoirs, a manual override such as by operation of a manual selector switch for example may be provided to provide manual control over the fluid flow rate, such as by providing manual control of the fluid flow control valve by a manual switch or lever, for example. In a particular embodiment, an accessory end cap may be provided to facilitate attachment and fluid connection of at least one secondary fluid reservoir and its primary duct or fluid passageway and fluid flow control valve to a known or commercially available native isolator product which comprises a primary fluid reservoir therein, such as a suitable hydro-pneumatic cylinder isolator. In one such embodiment, a suitable commercially available hydro-pneumatic cylinder isolator may be implemented as the native isolator, such as a Fox Float 3™ 5.25 inch or 10 inch hydro-pneumatic cylinder isolator available from Fox Manufacturing of Scotts Valley, Calif., U.S.A., for example.

In one embodiment of the present invention, an important aspect of the improved isolator design and function is the selection of the secondary reservoir volume. In one such embodiment, the cross sectional area, length and path of the primary duct or fluid passageway between the primary reservoir of an isolator cylinder and the secondary reservoir may desirably be selected such that the secondary reservoir volume achieves the highest or most improved shock mitigation performance across the range of anticipated suspension loads, or seat occupant weights for a particular application of the suspension system. In one such embodiment, the secondary reservoir volume may be selected such that a marginal increase in the selected secondary reservoir volume desirably only marginally decreases the natural frequency of local oscillations in the isolator with combined primary and secondary reservoir volumes when considered at an equilibrium point at approximately 85% of the compression range of the isolator, for example.

In one such embodiment, the secondary reservoir volume may be selected based on the natural frequency of local oscillations at any desired suspension load or seat occupant weight value for a desired application. In an exemplary embodiment where the secondary reservoir volume is desired to be openly fluidly connected to the primary reservoir when the lowest suspension load or occupant weight is set, the secondary reservoir volume may desirably be selected based on the natural frequency of local oscillations at the lowest suspension load or occupant weight of the design range. An exemplary relation between the frequency of local oscillations considered at 85% of the compression range and the secondary reservoir volume (expressed as a value of secondary reservoir volume/primary reservoir volume of the isolator) of an exemplary isolator comprising primary and secondary reservoirs at a range of suspension load or occupant weight values which may be used to select a desired secondary reservoir volume according to an exemplary embodiment of the present invention is shown below as Chart 1.

In another embodiment, the desired secondary reservoir volume may also be selected in consideration of the maximum secondary reservoir volume that may practically be attached to the isolator cylinder and fit within the enclosure or space available in a particular suspension system installation. For example, in an installation with a limited space available for the isolator and attached secondary reservoir volume, such as in applications where the isolator and secondary reservoir are integrated into a suspension component (such as a strut or well or enclosure) or a seat suspension applications where the combined isolator and attached secondary reservoir are integrated into a seat structure, the secondary reservoir volume may also desirably be selected so as to practically fit within the available space in a particular application.

In yet another embodiment, a shape of the secondary reservoir volume may be desirably selected so that the surface area of the secondary reservoir is desirably small relative to the volume of the secondary reservoir (i.e. such that the surface area is small relative to the volume taken at the limit as the length of the secondary reservoir becomes very large). Therefore, in one such embodiment, the shape of the secondary reservoir may desirably be selected so that the length along the long axis of the secondary reservoir does not dominate the cross-sectional length or width dimensions measured perpendicular to the long axis.

In a further embodiment, the cross-sectional area and length of a primary flow passageway or primary duct fluidly connecting the secondary reservoir to the primary reservoir may desirably be selected so as to provide fluid flow control for control of the flow of a fluid flowing between the primary and secondary reservoirs to desirably provide for improved shock mitigation performance of an isolator comprising primary and secondary reservoirs, according to an aspect of the present invention. In another embodiment, the cross sectional area of a primary duct opening in an end cap fluidly attached to the primary reservoir of the isolator cylinder and thereby fluidly connecting the primary reservoir to the primary duct may also desirably be selected so as to provide fluid flow control for control of a fluid flowing between the primary and secondary reservoirs. In one such embodiment, at least one of the cross sectional area of the primary fluid passageway or primary duct or the cross sectional area of the primary duct opening in the end cap may be selected to be sufficiently large so as to have substantially no contribution to the damping effect of the suspension system when the passageway or duct is open to fluid flow between the primary and secondary reservoirs. In a similar such embodiment, the length of the primary fluid passageway or primary duct may also desirably be selected to be sufficiently short in length so as to have substantially no contribution to the damping effect of the suspension system when the fluid passageway or duct is open to fluid flow between the primary and secondary reservoirs. In one such embodiment, the secondary reservoir may desirably be directly or proximately connected to the native isolator cylinder, such as to provide for a desirably shorter length of the primary duct in comparison with embodiments in which the secondary reservoir is not attached to the native isolator. In another embodiment, the primary fluid passageway or primary duct may also desirably comprise a fluid flow control valve so as to allow for control of fluid flow between primary and secondary reservoirs, and may also desirably pass through a manifold along the length of the fluid passageway or duct. In one such embodiment, the manifold may provide for structural attachment of the secondary reservoir to the end cap attached to the primary reservoir and native isolator cylinder, such as to provide for a desirably short primary duct length. In another embodiment, the manifold may desirably provide for location of sensors, or flow control devices such as valves or switches, or alternatively also for connection to additional secondary reservoirs such as to provide for fluid connection of additional secondary reservoir volumes to the primary reservoir of the isolator, for example.

In one embodiment, where the primary duct opening in the end cap and the primary duct comprise substantially circular cross sectional shapes, the diameter D of the primary duct and/or the primary duct opening, and the length L of the primary duct may be selected to desirably reduce or substantially avoid frictional drag and the associated damping effect on the suspension system due to fluid flow through the primary duct and primary duct opening. In one such embodiment, the diameter D of the primary duct and/or the primary duct opening, and the length L of the primary duct may be selected so the ratio of L/D<Lₑ, where Lₑ is the entrance length of the primary duct at which substantially fully frictional fluid flow has developed. In a particular such embodiment, primary duct entrance length Lₑ may be defined in relation to the anticipated Reynolds number Rₑ for the fluid flow through the primary duct, where Le is substantially equal to 4.4 R₃^{1/6}. In one embodiment, the value of Rₑ may typically depend on the diameter D of the primary duct and/or duct opening. In a more particular embodiment, the diameter D of the primary duct and/or the primary duct opening, and the length L of the primary duct may be selected so the ratio of L/D<24. In an aspect of the present invention directed towards very large diameters D of the primary duct and/or primary duct opening, or for aspects where fluid flow speeds are expected to be very low, the value for Rₑ may lie below a threshold and instead the value of the entrance length Lₑ=0.06 Rₑ may be used to select the diameter D and length L. In a particular such embodiment, the expressions for definition of entrance length Lₑ of the primary duct may be determined experimentally, for example. In a further optional embodiment, the primary duct opening in the end cap attached to the primary reservoir and cylinder of the isolator cylinder may desirably be selected to be as large as may be practicably applied without interfering with the motion of a primary piston reciprocating in the primary reservoir within the cylinder of the cylindrical isolator. In one such optional embodiment, the primary duct opening may be configured as substantially circular in cross sectional shape, while in a further optional embodiment, the primary duct opening may be substantially oval or elliptical in cross sectional shape particularly in aspects where such non-circular shapes may provide for a greater potential cross sectional area of the opening without undesirably interfering with the primary piston in the isolator cylinder, for example.

In a further embodiment of the present invention, a static operating pressure of the fluid in the primary and secondary fluid reservoirs may be selected so as to desirably provide for improved shock mitigation performance of an isolator comprising primary and secondary reservoirs. In one such embodiment, the pressure of the fluid in the primary reservoir may desirably be selected by determining the minimum pressure for which the isolator does not bottom out or exceed the allowable compression stroke length for the highest design acceleration with the highest design suspension load, or occupant weight. In other words, the minimum pressure for which the isolator does not exceed a maximum desired compression stroke length for the heaviest load or occupant (in the case of a seat suspension system) under the most extreme design operating condition (such as the maximum deck acceleration in a marine suspension seat application).

In another optional embodiment of the present invention directed to applications where a range of suspension loads or occupant weights are required, such as for suspension seat applications where seat occupants may vary over a substantial range of weights (such as from about 100 lb to 300 lb or over for example), a switching point or weight at which a valve between the primary and secondary reservoirs may be opened or closed to switch between a primary reservoir volume only and combined primary and secondary reservoir volumes may be selected so as to desirably provide for improved shock mitigation performance of an isolator comprising primary and secondary reservoirs over the range of suspension loads or occupant weights. In one such optional embodiment, a switching point or weight may desirably be selected by determining the particular suspension load or occupant weight at which the isolator does not exceed a maximum desired compression stroke length under the most extreme design operating condition (such as the maximum deck acceleration in a marine suspension seat application), when the primary and secondary reservoirs are fluidly connected (corresponding to when the fluid flow control valve and primary duct between the primary reservoir and secondary reservoir are open) and the reservoirs are at the desired static operating pressure as described above. The switching point or weight may then be selected to be less than that particular suspension load or occupant weight by a desired tolerance or factor of safety. Accordingly, in such an embodiment, the switching point or weight at which the operator may switch between use of the primary reservoir only and use of the combined primary and secondary reservoirs (such as by switching or otherwise opening or closing the fluid control valve between the primary and secondary reservoirs) may be determined to provide for improved shock mitigation performance over a range of suspension loads or occupant weights.

In a further embodiment of the present invention, a damping coefficient for the isolator comprising primary and secondary reservoirs may be selected to provide a desired compression rebound time so as to desirably provide for improved shock mitigation performance of an isolator comprising primary and secondary reservoirs over a design range of suspension loads or occupant weights and a design range of shock or input accelerations, for example. In one such embodiment directed to marine seat suspension applications, a damping coefficient for the isolator may be selected to provide a desired compression rebound time between about 0.2 to 0.5 seconds. In another embodiment, a desired compression rebound time range may be selected so as to allow for substantially full rebound of the isolator within a time interval less than a characteristic period of shock or input acceleration events, so as to provide for substantially full compression and rebound of the isolator between each shock event, for example.

In one embodiment according to the present invention, the configuration of an isolator comprising primary and secondary reservoirs fluidly connected by a primary duct or flow passageway passing through a manifold and through a primary duct opening in the end cap attached to the isolator cylinder may be determined by use of experimental testing iteration in order to select and determine desired configuration settings or characteristics such as the determination of secondary reservoir volume, primary duct or duct opening cross-sectional area and primary duct length, static operating pressure, and damping coefficient, as described above. In another alternative embodiment, a mathematical model may be developed, such as from synthesis of mechanical and physical principles and experimental results, to provide a suspension system model calibrated to a particular native isolator or isolators comprising primary and secondary reservoirs, such that input of shock acceleration profile and suspension load or occupant weight can be used to model suspended load or occupant experienced accelerations and isolator compression conditions, which may be used to select and determine desired suspension configuration settings or characteristics, such as those detailed above. In an optional such embodiment, the isolator may additionally comprise a fluid flow control valve further optional flow control system and the approaches of iterative testing or use of a mathematical suspension system model may be optionally used to further define a switching point or weight at which the fluid flow control valve between the first and second reservoirs may be opened or closed or otherwise controlled, for example.

In yet a further aspect according to an embodiment of the present invention, a method for configuring a suspension system using at least one of experimental testing iteration and a mathematical suspension system model is provided. In one such embodiment, the method comprises: first defining a suspension load range (such as an occupant weight range for a seat suspension system) and a shock or input acceleration profile (such as but not limited to at least one of magnitude, duration or frequency and shape of input acceleration pulses). Then a suitable native isolator comprising a primary reservoir (such as but not limited to a commercial isolator product and size and an isolator mounting linkage geometry if any which may determine relationship between isolator travel and travel of a suspended load or occupant seat surface for example) is determined. A secondary reservoir volume for a secondary reservoir may then be determined such as by determining a secondary reservoir volume for which a marginal increase in the selected secondary reservoir volume desirably only marginally decreases the natural frequency of local oscillations in the isolator with combined primary and secondary reservoir volumes when considered at an equilibrium point at approximately 85% of the compression range of the isolator, for example. A primary duct and/or duct opening cross-sectional area and primary duct length for a primary duct fluidly connecting the primary and secondary reservoirs may then be determined, such as by determining a cross-sectional area sufficiently large and a length sufficiently short so as to have substantially no contribution to the damping effect of the suspension system when the primary duct is open to fluid flow between the primary and secondary reservoirs. Then a static reservoir operating pressure may be selected such that the isolator does not bottom out or exceed allowable stroke for the greatest suspension load during the most extreme acceleration condition of the shock acceleration profile, such as by determining the minimum pressure for which the isolator does not bottom out or exceed the allowable compression stroke length for the highest design acceleration with the highest design suspension load, or occupant weight. Then a damping coefficient may be determined such as to provide for substantially full rebound of the isolator within a time interval less than a characteristic shock or input acceleration period, so as to provide for full compression and rebound of the isolator for substantially each shock event. In one particular embodiment directed to application in high speed marine vehicle seat suspension and an associated characteristic shock or input acceleration profile, a damping coefficient may be determined to desirably provide for a rebound time range between about 0.2 and 0.5 seconds, for example. In an optional embodiment, the method may also comprise determining a switching load or weight for a switching valve situated in the primary duct between the primary and secondary reservoirs such as by determining the particular suspension load or occupant weight at which the isolator does not exceed a maximum desired compression stroke length under the most extreme design operating condition (such as the maximum deck acceleration in a marine suspension seat application), when the primary and secondary reservoirs are fluidly connected (corresponding to when the fluid flow control valve and primary duct between the primary reservoir and secondary reservoir are open) and the reservoirs are at the desired static operating pressure as described above, and selecting the switching point or weight to be less than that particular suspension load or occupant weight by a desired tolerance or factor of safety.

In an additional aspect according to an embodiment of the present invention, the method for configuring the suspension system additionally comprises providing a suspension system comprising a native isolator having a primary reservoir; providing the secondary reservoir comprising the secondary reservoir volume; providing an end cap attached to the primary reservoir of the isolator cylinder and comprising a primary duct opening fluidly connected to the primary duct fluidly connecting the secondary reservoir to the primary reservoir by the primary duct of the cross-sectional area and length determined; and pressurizing the secondary reservoir to the static operating pressure determined. In a further optional embodiment, the method may additionally comprise providing a switching valve situated in the primary duct for controlling a rate of flow of a fluid between the primary and secondary reservoirs according to the switching weight In one embodiment, the method of configuring a suspension system may desirably provide for use of a maximum available range of isolator travel while preventing bottoming out or over-compression of the isolator over a defined range of suspension loads.

In another embodiment, the method of configuring a suspension system may desirably comprise using a mathematical suspension system model calibrated to a desired isolator comprising primary and secondary reservoirs, such that input of shock acceleration profile and suspension load or occupant weight can be used to model suspended load or occupant experienced accelerations and isolator compression conditions, which may be used to select and determine desired suspension configuration settings or characteristics, such as those detailed above. In another exemplary embodiment, the method of configuring a suspension system may desirably comprise using experimental testing iteration in order to select and determine desired configuration settings or characteristics such as the determination of secondary reservoir volume, primary duct or primary duct opening cross-sectional area and primary duct length, static operating pressure, damping coefficient, and optionally also switching point or weight, as described above. In yet another embodiment, the method of configuring a suspension system may further comprise determining a secondary reservoir shape such that the volume of the secondary reservoir is desirably large relative to a length along a long axis of the secondary reservoir (or alternatively that a length along a long axis of the secondary reservoir is desirably not too large relative to the cross-sectional width or height perpendicular to the long axis of the secondary reservoir), for example.

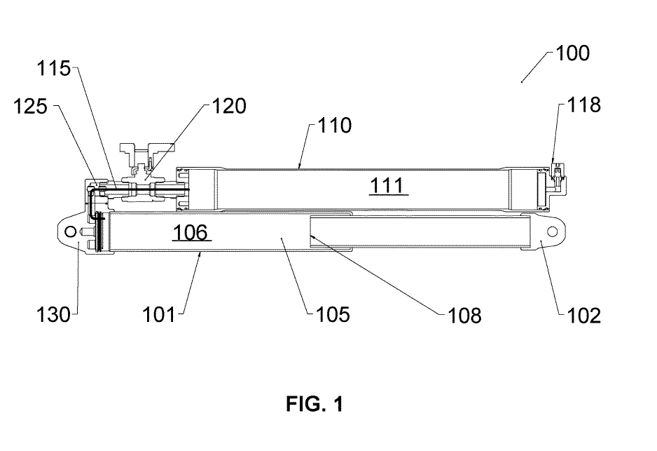

Referring now to FIG. 1, FIG. 1 illustrates a side view of a hydro-pneumatic cylinder isolator 100 having a secondary reservoir 110 attached to the primary reservoir 105 of the isolator 100 by a fluid passageway 115, manifold 125 and optional valve 120 in accordance with an embodiment of the present disclosure. In one embodiment, the isolator suspension system 100 comprises a cylinder 101, a primary reservoir 105 comprising a primary reservoir volume 106 disposed within the cylinder 101, a secondary reservoir 110 comprising a secondary reservoir volume 111 disposed within the secondary reservoir 110, a primary duct 115 connecting the primary reservoir 105 to the secondary reservoir 110 via a primary duct opening (not shown) in end cap 130 attached to cylinder 101, the primary duct 115 comprising a duct cross sectional area (not shown), and a duct length (not shown) such as to desirably provide for flow control of a fluid flowing between the primary 105 and secondary 110 reservoirs, for example. Isolator 101 may further optionally comprise a valve 120 such as a flow control valve, for controlling a flow rate of a fluid between the primary 105 and secondary 110 reservoirs by, for example, opening and closing the primary duct 115, and a manifold 125 disposed within the primary duct 115. Isolator 100 may be attached to a movable suspended load or weight by means of the suspension end connector 102, and to a base or support at the other end of isolator 100 by end cap 130. In one embodiment, end cap 130 may be retrofitted to a commercially available single cylinder hydro-pneumatic isolator cylinder 101 such as to provide for attachment and fluid connection with secondary reservoir 110. In one embodiment primary 105 and secondary 110 reservoirs may comprise at least one compressible fluid such as air, nitrogen or another suitable compressible fluid, for example.

In one embodiment, the primary duct 115 may comprise a continuous, substantially uniform cross sectional shape along the length of the duct 115, and may comprise a characteristic cross sectional area. In a particular embodiment, the duct 115 may comprise a tube having a substantially circular cross sectional shape. In one embodiment, the length of the primary duct 115 may typically comprise the total length of the duct 115 extending between the primary 105 and secondary 110 reservoirs. In an alternative embodiment, the isolator 110 may additionally comprise one or more additional secondary reservoirs (not shown) each comprising an additional reservoir volume (not shown). In one such embodiment, each additional secondary reservoir (not shown) may comprise an additional secondary duct (not shown) fluidly connecting the additional reservoir to the primary reservoir 105, and each additional secondary duct (not shown) may also comprise a secondary flow control valve (not shown) to control the flow of a fluid between such additional secondary reservoirs (not shown) and the primary reservoir 105, for example.

In one embodiment, isolator 100 may comprise a primary piston 108 disposed and moveable within cylinder 101 such as to provide for compression or extension of the isolator 100 for corresponding compression of the fluid contained in primary reservoir 105 to provide absorption of shock or impact through the compression stroke of piston 108 within isolator cylinder 101. In an optional embodiment, each secondary reservoir, such as secondary reservoir 110 may also optionally comprise a secondary piston (not shown).

In a particular embodiment, manifold 125 within primary duct or flow passageway 115 may additionally comprise one or more components of a control system (not shown) for controlling a flow rate of the fluid between the primary 105 and secondary 110 reservoirs. In one such embodiment, manifold 125 may comprise one or more pressure sensors (not shown), flow limiters or switches (not shown), or other control system components such as for a mechanical, electromechanical or electronic fluid flow control system, for example. In a particular such embodiment, other optional control system components such as a microcontroller, PLC, microprocessor, switches or other suitable control system components (not shown) such as for a mechanical, electromechanical or electronic fluid flow control system may be attached to or integrated with the end cap 130, manifold 125, valve 120 and secondary reservoir 110 of isolator 100 such as for implementing automatic, semi-active or manually adjustable fluid flow control of a fluid through primary duct 115 between primary reservoir 105 and secondary reservoir 110. In one embodiment, isolator 100 may also comprise a fluid pressurization port 118 such as for adding or withdrawing fluid from secondary reservoir 110 to set or adjust the pressure of a fluid in secondary reservoir 110, for example.

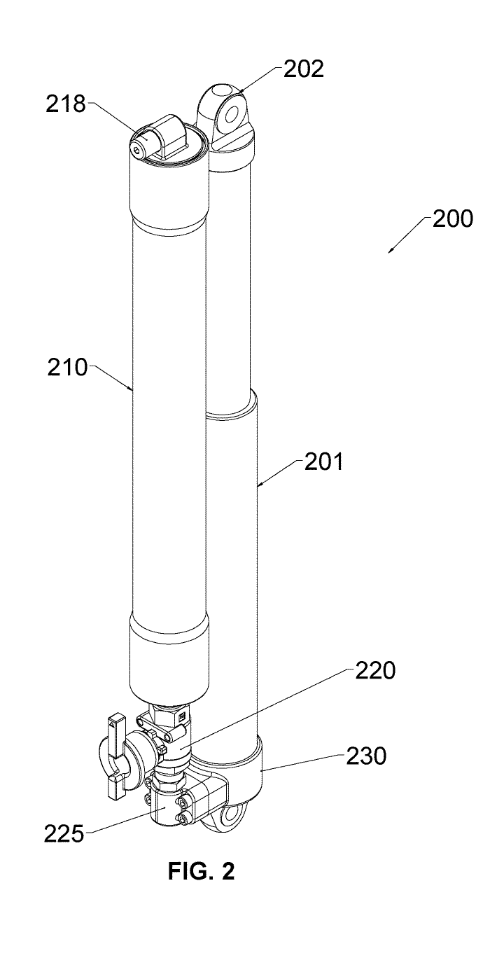

Referring now to FIG. 2, FIG. 2 illustrates a perspective view of a hydro-pneumatic cylinder isolator 200 in accordance with an embodiment of the present disclosure, and substantially similar to the isolator 100 shown in FIG. 1. Isolator 200 comprises a secondary reservoir 210 attached to the cylinder 201 of the isolator containing the primary reservoir of the isolator. Similar to as shown in FIG. 1, secondary reservoir 210 is fluidly connected to the primary reservoir in cylinder 201 of the isolator 200 by a primary duct or fluid passageway which comprises a manifold 225, and optionally also a flow control valve 220 in accordance with an embodiment of the present invention. Further, isolator 200 also comprises an end cap 230 which may be retrofitted to a commercially available single cylinder hydro-pneumatic isolator cylinder 201 such as to provide for attachment and fluid connection with secondary reservoir 210 through a primary duct opening (not shown) in the end cap 230, and a primary duct (not shown). In one embodiment primary (not shown) and secondary 210 reservoirs may comprise at least one compressible fluid such as air, nitrogen or another suitable compressible fluid, for example. Isolator 200 may be installed to suspend a movable suspension load or occupant seat such as by movable suspension end connector 202, and to a base by end cap 230 at the other end of the isolator 200. Similar to as shown in FIG. 1, in one embodiment isolator 200 may also comprise a fluid pressurization port 218 such as for adding or withdrawing fluid from secondary reservoir 210 to set or adjust the pressure of a fluid in secondary reservoir 210, for example.

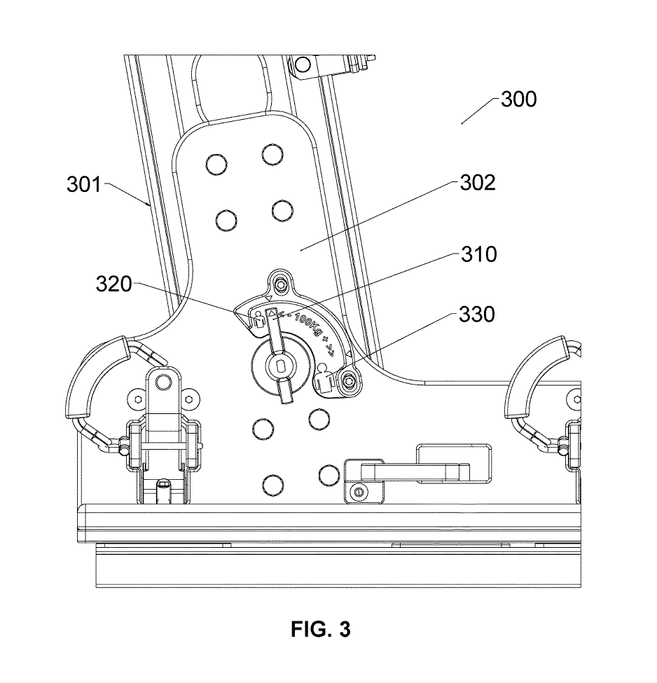

Referring now to FIG. 3, FIG. 3 illustrates a perspective view of a two (2) position (or detent) passive isolator reservoir volume selector system 300 attached to a marine vehicle seat base 302 in accordance with an embodiment of the present disclosure. In one embodiment, a selector lever or switch 310 may be connected to a fluid flow valve (not visible) which is connected to control fluid flow from a primary reservoir to a secondary reservoir of an isolator suspension system according to the invention (not visible) which provides shock adsorption between seat base 302 and a movable suspended portion (not shown) of the seat which may slide or otherwise move along a back rail or support 301 of the seat. Selector lever or switch 310 may enable a user to manually select a valve position and correspondingly control the flow of a fluid from the primary to secondary reservoirs of the isolator (not visible) by rotating the selector lever or switch 310. In one such embodiment, a first indicia 330 may represent a heavy suspension load or seat occupant weight condition corresponding to a closed position of a fluid flow control valve (not visible) when selected by moving the selector lever or switch 310 to first indicia 330. In such an embodiment, a second indicia 320 may represent a light or low suspension load or seat occupant weight condition corresponding to an open position of a fluid flow control valve (not visible) when selected by moving the selector lever or switch 310 to second indicia 320.

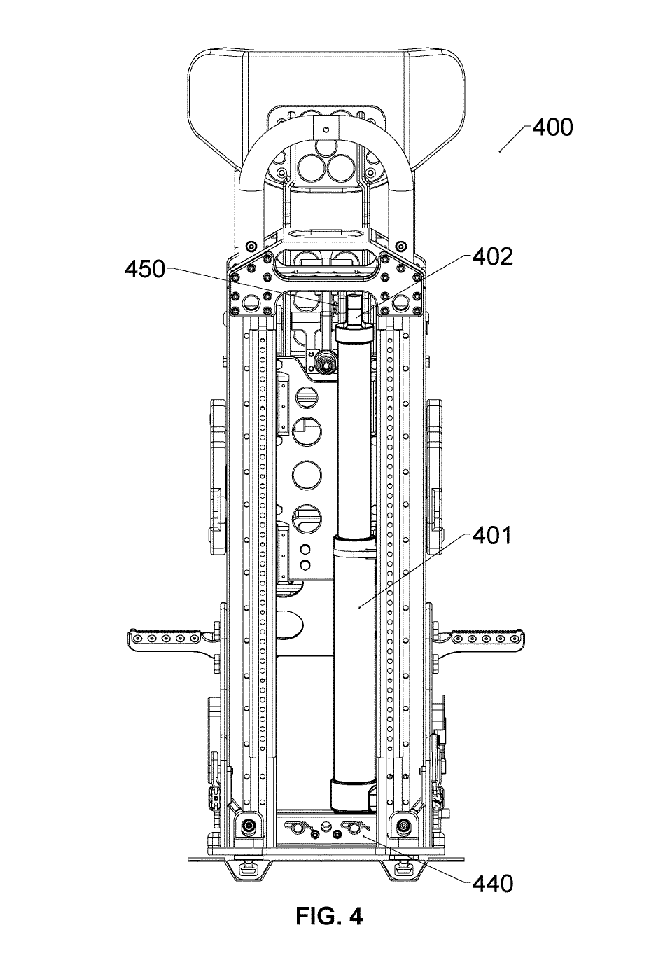

Referring to FIG. 4, FIG. 4 illustrates a rear perspective view of a shock-absorbing vehicle seat 400 incorporating a hydro-pneumatic cylinder isolator 401 having a secondary reservoir (not visible behind isolator 401) in accordance with an embodiment of the present invention. In one such embodiment, isolator 401 may desirably be attached between a fixed base 440 of the seat and to a moveable suspended portion 450 of the vehicle seat 400 such as by the moveable suspension end connector 402 of the isolator 401. Accordingly, isolator 401 comprising a secondary reservoir (not visible) may desirably provide for close integration and installation within a suitable shock absorbing suspended vehicle seat 400. In one particular embodiment, a hydro-pneumatic cylinder isolator 401 having a secondary reservoir (not visible behind isolator 401) in accordance with an embodiment of the present invention may desirably provide for retrofittable installation in an existing shock absorbing vehicle seat design 400, desirably allowing for cost effective adoption and installation into existing vehicle applications such as high speed marine vehicles (boats), and other suitable land, air and space vehicle applications.

In an optional embodiment, configuration of the suspension system comprising the isolator 100 such as determining desired values for the cross sectional area and length of the primary duct or fluid passageway 115 and/or area of a primary duct opening (not shown) in end cap 130 may optionally be determined by using an algorithm or model to have parameters to desirably maximize the efficiency of the secondary reservoir 110 in achieving shock mitigation by isolator 100. In one optional embodiment, an additional parameter which may optionally be determined by using an algorithm or model is a desired control switching point or weight to switch between use of primary reservoir 105 only and use of combined primary and secondary reservoirs 105 and 110 in operation of the isolator 100. In one embodiment, the secondary reservoir 110 may be larger in volume than the primary reservoir 105. In an alternative embodiment, the secondary reservoir 110 may be smaller in volume than the primary reservoir 105. In an exemplary embodiment directed to applications in seat suspension systems, a defined range of suspension loads may comprise a defined range of seat occupant weights, for example.

In an optional embodiment directed to application in suspension seats in marine vehicles (boats), a formula or mathematical model may optionally be employed to determine the primary duct or fluid passageway 115 size and shape in relation to the primary 105 and secondary 110 reservoir volume(s) and optionally also the control switching points for input conditions (occupant weight and sea conditions). In one such embodiment, the suspension system 100 may be controlled and adjusted manually, automatically (for example, by automatically controlling a valve using a computer and sensors), or by a hybrid of manual and automatic control features, in order to continually, actively, and repeatedly monitor the state of the suspension system. The switching may be manual, electromechanical or computer controlled, for instance in response to sensors on the vehicle and or manual and automatic inputs.

In one such optional embodiment, there may be a target switching point between use of a single reservoir, or reservoirs, for example, between the use of only the primary reservoir 105 and use of both the primary 105 and secondary 110 reservoirs, where the switching point is optionally determined by measuring a peak-to-peak ratio R between the acceleration of a target object, such as a seat in a marine vehicle, and the acceleration of the vehicle, for example, the deck of a marine vehicle, or some function of this ratio R including but not limited to a function that combines it with other factor(s) in order to select a switching point that minimizes the input acceleration(s) applied to the suspended occupant portion of the seat. In one such optional embodiment, a reservoir volume selection procedure switching point selection procedure for a system incorporating two reservoir volumes, one primary reservoir 105 permanently connected within the cylinder 101 of the isolator 100 and a secondary reservoir 110 that can be switched between being fluidly connected or isolated from the primary reservoir 105 may be described as follows:

Reservoir volume determination in one optional embodiment First, occupant weights or suspension load are defined with a probability distribution, typically a Normal distribution. This may then used to create a probability distribution for the mass suspended on the isolator.

Second, a desired relation between natural frequency of the isolator system (isolator and suspended mass) and stroke position may be defined. In one embodiment, possible relations include one in which the rate of change of the natural frequency with stroke position is substantially constant. Third, one reservoir volume may be selected so that the defined relation between the natural frequency and isolator stroke is obtained for a suspended weight that represents light occupants (the low end of the desired suspended weight range). Fourth, repeat the third step for a second reservoir volume for a suspended weight that represents heavy occupants (the high end of the desired suspended weight range).

Switching point determination process in one optional embodiment First, an input acceleration representative of the vertical deck acceleration encountered at sea is defined.

Second, the peak to peak SE-AT values over the range of suspended weights using the input acceleration from the first step may be calculated or experimentally measured for each of two cases: a) with the valve 115 open and, b) with the valve 115 closed.

In one embodiment, a switching point, W_{switch}, may be selected to desirably minimize the average of the peak to peak SE-AT values over the complete range of suspended weights according to the below formula:

$$\frac{\begin{matrix}{\{ \frac{{\int }_{{W}_{min}}^{{W}_{switch}} W S ( W )}{{\int }_{{W}_{min}}^{{W}_{switch}} S ( W )} d W \}}_{valve open} + \\ f ( {W}_{switch} ) = {\{ \frac{{\int }_{{W}_{switch}}^{{W}_{max}} W S ( W )}{{\int }_{{W}_{switch}}^{{W}_{max}} S ( W )} d W \}}_{valve closed}\end{matrix}}{{W}_{max} - {W}_{min}}$$

### Where,

weight
Wₘᵢₙ minimum suspended weight
Wₘₐₓ maximum suspended weight
W_{switch} switching point or switching weight
f(W_{switch}) average value of the peak to peak SE-AT value as a function of the switching weight
S(W) the SE-AT value as a function of weight

In one such optional embodiment, the value of W_{switch} may desirably be placed on a label on the suspended seat such as next to a manual control for the valve 115, to provide for manual switching by the seat operator, or alternatively in a case of automatic switching such as by an electronic control system, the value can be incorporated into control software or logic.

In further alternative embodiments, additional criteria may be used to select a switching weight including, for example, a criterion that the SE-AT value not to exceed a particular limit. In one embodiment, the desired minimization of input acceleration(s) may be defined in various ways, including but not limited to minimizing the average of the function which incorporates the ratio R across all suspended weights, or by minimizing the maximum value of the function incorporating the ratio R at any suspended weight.

In a further optional embodiment, a relationship among the cross sectional area of the primary duct 115, cross sectional area of the primary piston 108 disposed within the primary reservoir 105, and maximum speed of the primary piston 108 may be defined as follows:

A_{duct}≧C₁ Aₚᵢₛₜₒₙ Vₘₐₓ

wherein

A_{duct} is the cross sectional area of the primary duct 115 [sq. in.],

Aₚᵢₛₜₒₙ is the cross sectional area of the primary piston 108 [sq. in],

Vₘₐₓ is the maximum velocity of the primary piston 108 [in/s], and

C₁ is a constant substantially equal to 3.5×10⁻⁴ [s/in]

In an optional embodiment, the value of C₁ may range between about 3.0×10⁻⁴ and 4.0×10⁻⁴ [s/in]. In a further optional embodiment, C₁ is a constant equal to 3.5×10 ⁻⁴ [s/in]. In another optional embodiment, a relationship between the length of the primary duct 115 and the primary duct cross sectional area may be defined as follows:

0≦L_{duct}≦C₂A_{duct}

wherein

L_{duct} is the length of the primary duct 115 [in.],

A_{duct} is the cross sectional area of the duct 115 [sq. in.], and

C₂ is a constant substantially equal to 76.5 [in⁻¹]. In an optional embodiment, the value of C₂ may range between about 75 and 78 [in⁻¹]. In a further optional embodiment, C₂ is a constant equal to 76.5 [in⁻¹].

Also in a particular embodiment directed to marine vehicle applications, the cylinder 101 of isolator 100 may be connected to the seat of a marine vehicle user in order to dampen the gravitational forces, or G-forces which may be encountered in high speed marine operations, and which may typically range from about 0-16 g for example in an embodiment directed to a high speed marine vehicle.

In another particular embodiment, the length and cross sectional area of the primary duct or fluid passageway 115 between the primary reservoir 105 of the isolator 100 and the secondary reservoir 110 may be shorter and larger, respectively, than the corresponding length and cross sectional area of a fluid passageway such as a fluid bypass in conventional single reservoir isolators for suspended seats. In one optional embodiment according to the present invention, a ratio between the length and cross sectional area of the primary duct 115 and the volume of the primary 105 and secondary 110 reservoirs may desirably be determined by using at least one of a mathematical theory or model and experimental testing results to achieve a desirably consistent and high level of shock mitigation across different suspension payloads such as seat occupant weights of a range of occupants of a suspended seat.

According to one embodiment of the invention, a challenge associated with suspension of vehicle seats is to provide a desirably simple, easy to use suspension system for a suspended vehicle seat such as a marine vehicle seat. Often in certain embodiments directed to high speed marine vehicles, the operator or user of a seat may be traveling in high impact conditions, sometimes at night or in variable weather such as fog, rain, sleet or spray, with large wave and swell heights. For seat suspension systems requiring control input by an operator, control selections must be simple and accessible from harnessed seating positions. Certain currently known or available marine seats may provide undesirably complex control inputs requiring instruction manuals to select between multiple seat suspension controls and multiple detents on each control, leading to input errors, thereby increasing the risk of injury or accident or suspension maladjustment. In one embodiment according to the present invention, a seat suspension system comprising primary and secondary reservoirs and requiring no user control input may be provided. In another embodiment according to the invention, a simple two (2) position (or detent) seat suspension adjustment is provided for control of a valve 120 between a primary 105 and secondary 110 reservoirs of a seat suspension isolator 100, in order to achieve desirably similar and effective shock mitigation in a marine seat isolator for seat occupant weights over a wide range, such as from 90 pounds to 180 pounds or up to 300 pounds or more, while maintaining a simple user control.

In an alternative embodiment, switching between primary 105 and one or more secondary 110 reservoirs can be controlled automatically, such as based on a sensor identifying the weight of the suspension payload such as the weight of an occupant of a marine seat, which may in one aspect include for instance the seat user and his or her equipment and clothing, and optionally also the weight of the empty suspended portion of the seat. In another embodiment, such switching may be controlled based on one or more sensors identifying one or more parameters such as compression travel of the isolator 100, acceleration profile of the shock or input acceleration, or other suspension related parameters, for example. In an additional embodiment the isolator 100 with one or more secondary reservoirs 110 may be semi-actively controlled, such as having control of switching between primary and secondary reservoirs (and thereby affecting damping of the suspension system) be achieved by response from one or more sensors and control by a programmable logic controller (PLC), microcontroller or other suitable mechanical, electromechanical or electronic control system, for example.

In a further embodiment, a passive control system comprising primary and secondary reservoirs and requiring no input from a user may be provided, and in another embodiment a passive control system comprising primary and secondary reservoirs and comprising a two (2) option or position selector for selecting between light and heavy suspension payloads may be implemented, such as to desirably provide improved shock mitigation performance over a range of suspension payloads relative to existing semi-active systems, while also providing simpler components and lower costs to manufacture and desirably also to maintain and operate.

A particular embodiment of the present isolator system 100 may be adapted for a marine environment by providing suspension components manufactured at least in part of light aluminium and/or stainless steel machined components resistant to corrosion in salt water, versus typically heavy, larger components of welded steel which may be typical for applications to land vehicles.

An additional embodiment of the present invention may employ an isolator 100 with air switch engagement for actuation. Another embodiment may comprise an isolator for a seat in military vehicles with one or more secondary reservoirs 110 automatically engageable for unexpected or emergency situations, such as blast attenuation for example.

Information as herein shown and described in detail is fully capable of providing the above-described advantages of the present disclosure, the presently preferred embodiment of the present disclosure, and is, thus, representative of the subject matter which is broadly contemplated by the present disclosure. The scope of the present disclosure fully encompasses other embodiments and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, are also encompassed by the present disclosure.

### INDUSTRIAL APPLICABILITY

The present disclosure industrially applies to a shock absorbing apparatus and system for a suspension of a single suspended component, such as a seat for example, and having a plurality of pneumatic reservoirs including a primary and at least one secondary reservoir. More specifically, the present disclosure industrially applies to shock absorbing apparatus and systems for mitigating force applied to a seat in a vehicle, such as a marine vehicle for example, such that the g forces or other impact forces due to operational conditions, such as high speed adverse environments including wave action, are desirably minimalized with respect to the suspended human passenger or user, or other impact-sensitive suspension load such as impact-sensitive equipment. Even more specifically, the present disclosure industrially applies to shock absorbing systems with a passive control system which desirably optimizes the length and cross sectional area of a primary duct or fluid passageway connecting a secondary pneumatic reservoir to the primary reservoir of an isolator, and also the volume of the secondary reservoir in a manner to desirably optimize shock mitigation for a range of suspended weights such as the weight of an occupant on a suspended seat comprising the system. Other industrial applications include, but are not limited to, facilitating shock mitigation to human users in blasts or explosions, marine, land, air and space vehicle seat shock absorbing, and other isolator systems for seats, or for other suspension systems including hydro-pneumatic isolators.

The scope of the present disclosure fully encompasses other embodiments and is to be limited, accordingly, by nothing other than the appended claims, wherein any reference to an element being made in the singular is intended to mean “one or more”, and is not intended to mean “one and only one” unless explicitly so stated. All structural and functional equivalents to the elements of the above-described preferred embodiment and additional embodiments are hereby expressly incorporated by reference and are intended to be encompassed by the present claims. Moreover, no requirement exists for an apparatus or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the scope of the present disclosure, as set forth in the appended claims, are also encompassed by the present disclosure.

What is claimed is:

1. A suspension system comprising:
an isolator cylinder, comprising a primary reservoir having a primary reservoir volume;
a secondary reservoir having a secondary reservoir volume;
an end cap attached to the primary reservoir of the isolator cylinder and comprising a primary duct opening fluidly connected to a primary duct;
a primary duct fluidly connecting the primary reservoir to the secondary reservoir; and;
a manifold through which the primary duct passes;
wherein at least one of the primary duct opening and the primary duct are configured to control a flow rate of a fluid through the primary duct between the primary and secondary reservoirs.

2. The suspension system according to claim 1 wherein the primary duct comprises a cross sectional area A and a length L such that a fluid flowing through the primary duct between the primary and secondary reservoirs does not contribute to a damping of the isolator cylinder.

3. The suspension system according to claim 1, wherein the primary duct comprises a diameter D and a length L such that a ratio of L/D is less than about 24.

4. The suspension system according to claim 1, wherein the primary reservoir comprises a primary piston having a cross sectional area Aₚᵢₛₜₒₙ; and primary duct comprises a cross sectional area A_{duct} and a Length L, such that A_{duct}≧C₁ Aₚᵢₛₜₒₙ Vₘₐₓ; wherein
A_{duct} is the cross sectional area of the primary duct in square inches,
Aₚᵢₛₜₒₙ is the cross sectional area of the primary piston in square inches,
Vₘₐₓ is a maximum velocity of the primary piston in inches/second, and
C₁ is a constant substantially equal to 3.5×10⁻⁴ [s/in].

5. The suspension system according to any one of claims 1 to 4, additionally comprising a valve for controlling a flow rate of a fluid through the duct; and
a control system for operating the valve for controlling the flow rate of the fluid between the primary and secondary reservoirs.

6. The suspension system according to claim 5, wherein the control system comprises at least one of a switch and a selector, and wherein said control system is operable to select between an open and a closed position of the valve.

7. The suspension system according to any one of claim 5 or 6, wherein the control system is operable to select between a first position of the valve corresponding to a first suspension load and a second position of the valve corresponding to a second suspension load.

8. The suspension system according to any one of claim 6 or 7, wherein the control system is at least one of: manually operable by a user, and automatically controlled.

9. The suspension system according to claim 5, wherein the control system comprises:
a sensor for measuring an external force due to a suspension load,
a microprocessor for detecting the external force measured by the sensor, and determining a control input corresponding to a position of the valve; and
a controller for receiving the control input and adjusting the position of the valve to control the flow of a fluid between the primary reservoir and the secondary reservoir.

10. The suspension system according to claim 9, wherein the controller comprises at least one of an actuator and a switch.

11. The suspension system according to any one of claim 9 or 10, wherein the control system additionally comprises a power source for delivering power to at least one of the microprocessor and the controller.

12. The suspension system according to any one of claims 9 to 11, wherein the controller is manually operable to override the control input.

13. The suspension system according to any one of claims 1 to 12, wherein the fluid comprises at least one of a compressible gas, air and nitrogen.

14. The suspension system according to claim 5, wherein the control system comprises:
a sensor for measuring an external force due to a weight of a vehicle seat in an occupied state;
a microprocessor for storing and comparing a predetermined force due to a weight of the vehicle seat in an unoccupied state and the external force due to a weight of the vehicle seat in an occupied state; and
a controller for adjusting the valve based on a differential between the external force due to the weight of the seat in an occupied state and the predetermined force due to the weight of the seat in an unoccupied state.

15. The suspension system according to any one of claims 5 to 12 and 14, additionally comprising:
at least one additional secondary reservoir comprising an additional secondary reservoir volume;
at least one secondary duct fluidly connecting the at least one additional secondary reservoir to the primary reservoir;
at least one additional valve for controlling a flow rate of a fluid through the at least one secondary duct; and
wherein the control system is additionally adapted for operating the at least one secondary valve for controlling the flow rate of the fluid between the primary and the at least one additional secondary reservoir.

16. A suspended vehicle seat comprising the suspension system according to any one of claims 1 to 15.

17. The suspended vehicle seat according to claim 16, wherein the vehicle seat comprises a marine vehicle seat.

18. A method for absorbing shock transferred to a seat in a vehicle, the method comprising:
providing a suspension system according to any one of claims 5 to 12 and 14, and
controlling a position of the at least one valve in response to an occupant weight of an occupant of the seat, to control the shock absorption response of the suspension system.

19. The method according to claim 18, wherein the method further comprises:
providing a stored predetermined force due to the weight of the seat in an unoccupied state to the control system;
measuring an external force due to a weight of the seat in an occupied state;
determining a force differential between the stored predetermined force and the external force; and
adjusting the flow of a fluid between the primary reservoir and the at least one secondary reservoir by controlling the position of the at least one valve in response to the force differential between the stored predetermined force and the external force to control the shock absorption response of the suspension system.

20. A method for configuring a suspension system comprising:
defining a suspension load range and a shock acceleration profile comprising at least one of a magnitude, duration and period of a shock acceleration;
selecting an isolator comprising a primary reservoir having a primary reservoir volume;
determining a secondary reservoir volume for a secondary reservoir fluidly connected to the primary reservoir;
determining a primary duct cross-sectional area and length for a primary duct fluidly connecting the primary and secondary reservoirs;
determining a reservoir pressure based on a maximum allowable isolator stroke at a maximum suspension load for a maximum acceleration magnitude of the shock acceleration profile; and
determining a damping coefficient to provide an isolator rebound time less than the period of the shock acceleration in the shock acceleration profile.

21. The method of configuring a suspension system according to claim 20, additionally comprising: determining a switching load for a switching valve situated in the primary duct for controlling the flow of a fluid between the primary reservoir and the secondary reservoir;

22. The method of configuring a suspension system according to claim 20, additionally comprising:
providing a suspension system comprising an isolator cylinder comprising a primary reservoir having a primary reservoir volume;
providing the secondary reservoir comprising the secondary reservoir volume;
providing an end cap attached to the primary reservoir of the isolator cylinder and comprising a primary duct opening fluidly connected to the primary duct;
providing the primary duct fluidly connecting the secondary reservoir to the primary reservoir and comprising the primary duct cross-sectional area and length; and
pressurizing the secondary reservoir at the pressure determined.

23. The method of configuring a suspension system according to claim 22; additionally comprising:
determining a switching load for a switching valve situated in the primary duct for controlling the flow of a fluid between the primary reservoir and the secondary reservoir; and
providing a switching valve disposed in the primary duct for controlling a rate of flow of a fluid between the primary reservoir and the secondary reservoir according to the switching load.

24. The method of configuring a suspension system according to any one of claims 20 to 23, wherein the suspension system comprises a vehicle seat suspension system and the suspension load range comprises a seat occupant weight range.

25. The method of configuring a suspension system according to any one of claims 20 to 24, wherein the suspension system comprises a marine vehicle seat suspension system.

26. The method of configuring a suspension system according to claim 20 wherein determining a damping coefficient additionally comprises determining a damping coefficient to provide an isolator rebound time of between 0.2 and 0.5 seconds.
